(19) United States
(12) Patent Application Publication
(10) Pub. No.: US 2026/0112100 A1
(43) Pub. Date: Apr. 23, 2026

(54) ANIMATION QUEUE OPTIMIZATION METHOD AND PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventor: YUNFEI SI, Jiangsu (CN)

(21) Appl. No.: 19/250,278

(22) Filed: Jun. 26, 2025

(30) Foreign Application Priority Data
Oct. 23, 2024 (CN) 2024114882720

(51) Int. Cl. G06T 13/80

(52) U.S. Cl. CPC G06T 13/80

(57) ABSTRACT

An animation queue optimization method includes obtaining an animation queue and playing animations in the animation queue, recording user operations performed during the playback of each animation in the animation queue, and adjusting the animations and/or the playback order of the animations in the animation queue based on the user operations to obtain an optimized animation queue. The method can optimize the animation queue pushed to users, thereby achieving better push effects.

### CROSS REFERENCE TO RELATED APPLICATION AND CLAIM OF PRIORITY

This application claims the benefit under 35 USC § 119 of Chinese Patent Application No. 2024114882720 filed on Oct. 23, 2024, in the Chinese Intellectual Property Office, the entire disclosure of which is incorporated herein by reference for all purposes.

### BACKGROUND

### 1. Technical Field

This disclosure generally relates to the technical field of animation. More specifically, this disclosure relates to an animation queue optimization method and related products.

### 2. Background Art

With development of internet technology, online shopping platforms have become the most preferred choice for many users due to their convenience and variety, greatly promoting the prosperity of the consumer market. On these online shopping platforms, to attract users, merchants choose to create animations with vivid visual effects and rich information to replace static product images. When users enter promotional pages of stores, the platform automatically pushes pre-configured animations to showcase discount information and promotional offers, aiming to stimulate users' purchasing desire.

However, existing animations lack mechanisms for monitoring and analyzing user behavior. Merchants push animations equally to all users visiting the store or promotional pages, regardless of whether they are genuinely interested in the promoted products or have potential purchasing intent. This non-targeted approach makes it difficult to accurately capture users' real needs and improve product sales, resulting in poor push effects for animations.

Therefore, there is an urgent need to provide an animation queue optimization method and related products to enhance the push effects of animations.

### SUMMARY

To at least address one or more of the technical problems mentioned above, this disclosure proposes an animation queue optimization method and related products in various aspects.

In a first aspect, this disclosure provides an animation queue optimization method, characterized in including: obtaining an animation queue and playing animations in the animation queue; recording user operations performed during the playback of each animation in the animation queue; and adjusting the animations and/or the playback order of the animations in the animation queue based on the user operations to obtain an optimized animation queue.

In some embodiments, the user operations autonomous operations performed by the user during animation playback and response operations made by the user in response to interactive requests issued by the animations.

In some embodiments, the step of adjusting the animations and/or the playback order of the animations in the animation queue based on the user operations to obtain an optimized animation queue includes: if the user operations include target user operations, performing a first adjustment operation on the animations and/or the playback order of the animations in the animation queue to obtain the optimized animation queue; and if the user operations do not include target user operations, performing a second adjustment operation on the animations and/or the playback order of the animations in the animation queue to obtain the optimized animation queue.

In some embodiments, the target user operations include skip and/or exit operations.

In some embodiments, the first adjustment operation includes at least one operation of modifying, reordering, text replacing, duration shortening, and deleting; the second adjustment operation includes at least one operation of retaining and adding to other animation queues.

In some embodiments, during the playback of animations in the animation queue, the method further includes: if a skip operation for the current animation is detected, terminating the playback of the current animation; continuing to play the next animation in the animation queue according to the playback order of the animation queue; and if an exit operation for the current animation is detected, terminating the playback of the animation queue.

In some embodiments, the animation queue optimization method further includes: if the playback of the current animation queue is not completed and a playback operation for another animation queue is triggered, adjusting the playback order of the other animation queue to be preceded by the current animation queue.

In some embodiments, after recording the user operations performed during the playback of each animation in the animation queue, the method further includes: recording newly added user collection data within a continuous period after the playback of the animation queue ends; and adjusting the animations and/or the playback order of the animations in the animation queue based on the user operations and the collection data to obtain the optimized animation queue.

In a second aspect, this disclosure provides an apparatus for an animation queue optimization method, characterized in including: an animation playback module, configured to obtain an animation queue and play animations in the animation queue; a data recording module, configured to record user operations performed during the playback of each animation in the animation queue; and an animation optimization module, configured to adjust the animations and/or the playback order of the animations in the animation queue based on the user operations to obtain an optimized animation queue.

In a third aspect, this disclosure provides a computer-readable storage medium having computer instructions stored thereon, characterized in that the computer instructions, when executed by a processor, cause the processor to perform the method according to the first aspect and any embodiment thereof.

According to the animation queue optimization method provided above, the embodiments of this disclosure adjust the animations and/or the playback order of the animations in the animation queue based on user operations, enabling the adjusted animation queue to align with user preferences, thereby improving the push effects of animations.

### BRIEF DESCRIPTION OF THE DRAWINGS

By referring to the detailed description of the embodiments below in conjunction with the accompanying drawings, the above and other objectives, features, and advantages of the exemplary embodiments of this disclosure will become more comprehensible. In the drawings, several embodiments of this disclosure are shown in an exemplary rather than limiting manner, and the same or corresponding reference numerals denote the same or corresponding parts, wherein:

FIG. 1 shows a flowchart of an animation queue optimization method according to some embodiments of this disclosure;

FIG. 2 shows a flowchart of an animation queue optimization method according to some embodiments of this disclosure;

FIG. 3 shows a flowchart of an animation queue optimization method according to some embodiments of this disclosure;

FIG. 4 shows an exemplary flowchart of an animation queue optimization method according to some embodiments of this disclosure;

FIG. 5 shows a structural block diagram of an apparatus for an animation queue optimization method according to some embodiments of this disclosure.

### DETAILED DESCRIPTION

The technical solutions in the embodiments of this disclosure will be described clearly and completely below with reference to the accompanying drawings. It is apparent that the described embodiments are only a part instead of all of the embodiments of this disclosure. Based on the embodiments of this disclosure, all other embodiments obtained by those skilled in the art without creative efforts shall fall within the protection scope of this disclosure.

It should be understood that the terms “comprising” and “including” used in the specification and claims of this disclosure indicate the presence of the described features, entities, steps, operations, elements, and/or components, but do not exclude the presence or addition of one or more other features, entities, steps, operations, elements, components, and/or sets thereof.

It should also be understood that the terminology used herein is for the purpose of describing specific embodiments only and is not intended to limit the disclosure. As used in the specification and claims of this disclosure, the singular forms “a,” “an,” and “the” are intended to include the plural forms unless the context clearly indicates otherwise. It should also be further understood that the term “and/or” as used in the specification and claims of this disclosure refers to any combination of one or more of the associated listed items and all possible combinations, and includes these combinations.

As used in the specification and claims of this disclosure, the term “if” may be interpreted contextually as “when,” “once,” “in response to determining,” or “in response to detecting.” Similarly, the phrase “if it is determined” or “if [a described condition or event] is detected” may be interpreted contextually as meaning “once it is determined,” “in response to determining,” “once [a described condition or event] is detected,” or “in response to detecting [a described condition or event].”

The embodiments of this disclosure will be described in detail below with reference to the accompanying drawings.

### Exemplary Application Scenarios

As the core platform for product display and transactions in the digital retail environment, the precision and creativity of marketing strategies on online shopping platforms directly impact users' shopping experience and merchants' business performance. Merchants widely use promotional animations to stimulate users' purchasing desire. However, this strategy has inherent limitations.

First, the current promotional model lacks personalization and precision. Merchants push animations equally to all users visiting the store or promotional pages, regardless of whether they are genuinely interested in the promoted products or have potential purchasing intent. This non-targeted approach not only is inefficient but also forces merchants to increase push frequency or purchase more ad space to compensate for low conversion rates. Second, for users, frequently receiving promotional information they are not interested in may cause annoyance and resistance, leading to negative impressions of the merchant or even the entire platform, affecting user loyalty and repurchase rates.

Therefore, there is an urgent need to provide an animation queue optimization method and related products to achieve targeted and precise animation pushes for different users, improve the push effects of animations, enhance user experience, and increase product sales.

### Exemplary Application Solutions

In view of this, the embodiments of this disclosure provide an animation queue optimization method. By recording user operations performed during animation playback and optimizing the animation queue based on these operations, the method can obtain an animation queue that better aligns with user preferences and consumption needs.

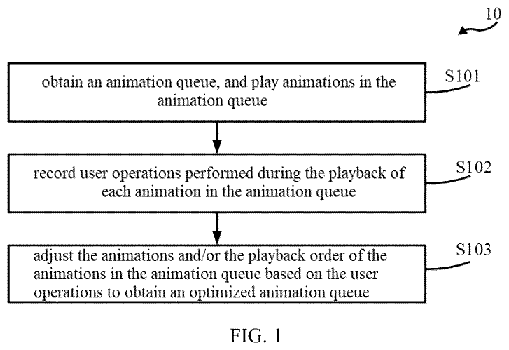

Referring to FIG. 1, which shows a flowchart of an animation queue optimization method 10 according to some embodiments of this disclosure. As shown in FIG. 1, in step S101, the method 10 obtains an animation queue and plays animations in the animation queue. In some embodiments, when a user enters a promotional page or triggers a playback operation for the animation queue on the promotional page, a pre-configured animation queue is obtained, and animations in the animation queue are played sequentially according to the playback order of the animation queue. The playback order of the animation queue follows the first-in-first-out (FIFO) rule, meaning the earliest-added animation is played first, followed by subsequently added animations.

For example, when a user clicks a link or button corresponding to animation playback on the promotional page, it is considered as triggering the playback operation for the animation queue. The link or button for animation playback can be located within the animation playback interface area or in other areas of the promotional page.

In other embodiments, the playback order of the animation queue can also be a specific order pre-configured by the merchant or platform. For example, the priority of each animation in the animation queue can be pre-set, so that during playback of animations in the animation queue, animations are played in an order of their priority.

Next, the process proceeds to step S102. In step S102, the method 10 records user operations performed during the playback of each animation in the animation queue. In the embodiments of this disclosure, the user operations may include autonomous operations performed by the user during animation playback and response operations made by the user in response to interactive requests issued by the animations. For example, autonomous operations may include various actions and operations that users can freely and actively perform, including, for example, play, pause, fast-forward, volume adjustment, adding to favorites, shopping cart, sharing with others, exiting, or skipping the current animation. Response operations refer to selective operations made by users in response to interactive requests automatically issued by the animations. For instance, during animation playback, the animation page may automatically pop up an interactive request such as “Continue playback” with two options: A: Yes, B: No. The user's choice between A and B constitutes the response operation. These user operations reflect the user's preference for the currently playing animation, which can further indicate the user's preference for the products featured in the animation.

In some embodiments, no interactive requests are issued during animation playback, in which case the user operations may only include autonomous operations performed by the user during playback of animations.

In some embodiments, the user operations may carry an animation identifier for the currently playing animation, so that the user operations corresponding to each animation can be identified during subsequent optimization of the animation queue. In other embodiments, the user operations and animation identifiers may be recorded separately. In this case, step S102 may include: recording the user operations performed during the playback of each animation in the animation queue and the animation identifier of the currently playing animation. This disclosure does not impose specific limitations on this.

In some embodiments, a logging system can be used to record the user operations performed during the playback of each animation in the animation queue to improve the reliability and security of the records. Those skilled in the art may make modifications when implementing the embodiments of this disclosure, such as storing the operations using a self-developed recording system, a storage server, or a memory, or directly storing the operations locally.

Finally, the process reaches step S103. In step S103, the method 10 adjusts the animations and/or the playback order of the animations in the animation queue based on user operations to obtain an optimized animation queue. In the embodiments of this disclosure, the user operations reflect the user's preference for each animation in the animation queue. Therefore, by adjusting the animations and/or the playback order of the animations in the animation queue based on the user operations corresponding to each animation, the adjusted animation queue can align with the user's preferences to meet their real needs, thereby achieving targeted and precise animation pushes, improving user experience, and increasing product sales.

In some embodiments, step S103 may be executed after the playback of the animation queue ends. In other embodiments, step S103 may be executed when the playback count or placement duration of the animation queue meets preset conditions. The preset conditions may include the playback count being greater than or equal to a preset playback count, or the placement duration being greater than or equal to a preset duration. For example, the preset playback count may be set to 10, and the preset duration may be set to 1 week. By counting the same user's operations for each animation in the animation queue multiple times and adjusting the animations and/or the playback order of the animations in the animation queue based on the counted user operations, an impact of random errors can be reduced, thereby enhancing the reliability of the optimized animation queue, further enhancing the push effects of animations, improving the user experience, and increasing the product sales.

In some embodiments, after executing step S103 to obtain the optimized animation queue, when the user re-enters the promotional page or triggers the playback operation for the animation queue on the promotional page, step S101 may be executed again. In this case, an animation queue obtained by the method 10 is an optimized animation queue from the previous iteration. By continuously optimizing the animation queue, the alignment between the animation queue and the user can be significantly improved, further enhancing the push effects of animations.

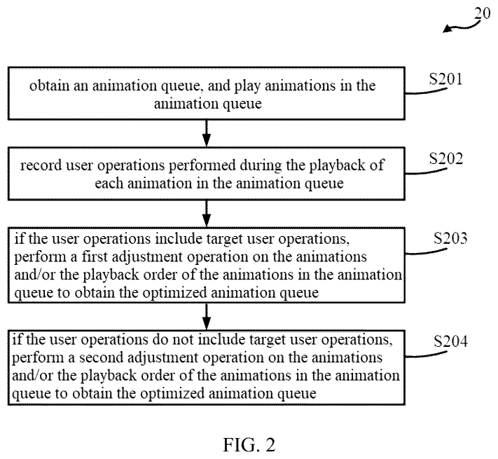

The animation queue optimization method 10 of this disclosure is described above in conjunction with FIG. 1. The embodiments of this disclosure adjust the animations and/or the playback order of the animations in the animation queue based on user operations to obtain an optimized animation queue, enabling the adjusted animation queue to align with the user's real needs, achieving targeted and precise animation pushes, improving user experience, and increasing product sales. However, it should be understood by those skilled in the art that the method shown in FIG. 1 is exemplary rather than limiting, and adjustments can be made by those skilled in the art as needed. Multiple embodiments and variations of the method 10 of this disclosure will be further described below in conjunction with FIG. 2.

Referring to FIG. 2, which shows a flowchart of an animation queue optimization method 20 according to some embodiments of this disclosure. As shown in FIG. 2, first, in step S201, the method 20 obtains an animation queue and plays animations in the animation queue. Then, in step S202, the method 20 records user operations performed during the playback of each animation in the animation queue. It should be noted that steps S201 and S202 may be the same as or similar to steps S101 and S102 described above in conjunction with FIG. 1, and thus will not be repeated here.

After executing step S202, the process proceeds to step S203 or step S204. If the user operations include target user operations, the method 20 executes step S203; if the user operations do not include target user operations, the method 20 executes step S204. In the embodiments of this disclosure, the target user operations may include skip and/or exit operations. If the user operations include skip and/or exit operations, it indicates that the user's preference for the current animation is low. Conversely, if the user operations do not include skip and/or exit operations, it indicates that the user's preference for the current animation is high.

In some embodiments, the target user operations may also include negative response operations made by the user in response to interactive requests issued by the animations. For example, response operations that are unfavorable to the continued playback of the current animation may be considered negative response operations. For instance, at the time of playback of Animation 1, an interactive request such as “Continue playback?” with two options: A: Yes, B: No is issued, and the B response operation is a negative response operation. Similarly, at the time of playback of Animation 2, an interactive request such as “Are you interested in the product featured in the animation?” with three options: A: Yes; B: No; C: Other is issued, and the B and C response operations are considered negative response operations.

Specifically, in step S203, the method 20 performs a first adjustment operation on the animations and/or the playback order of the animations in the animation queue to obtain an optimized animation queue. The first adjustment operation may include at least one operation of modifying, reordering, text replacing, duration shortening, and deleting. For example, the text in the animation may be replaced, and/or the playback order of the animation with modified text in the animation queue may be adjusted to a later position. Alternatively, the order of the text content in the animation may be rearranged. This disclosure does not impose specific limitations on this. Those skilled in the art may make modifications when implementing the embodiments of this disclosure, such as directly deleting unnecessary text content in the animation to shorten the playback duration or directly deleting the animation.

In some embodiments, step S203 may further include: the method 20 counts a frequency of target user operations and performs the first adjustment operation on the animations and/or the playback order of the animations in the animation queue only when the frequency is greater than or equal to a first preset frequency. When the frequency of target user operations is high, it can be accurately determined that the user's preference for the animation is low, thereby further improving the push effects of animations.

In a further embodiment, prior to step S203, the method 20 may pre-set frequency intervals for each operation or combination of operations in the first adjustment operation and associate the frequency intervals with the corresponding operations or combinations. It should be understood that the operations and combinations described here refer to at least one operation of modifying, reordering, text replacing, duration shortening, and deleting as mentioned above. Step S203 may then include: the method 20 counts a frequency of target user operations, determines the specific operation in the first adjustment operation based on the frequency, and performs the specific operation on the animations and/or the playback order of the animations in the animation queue. In the embodiments of this disclosure, when counting the frequency of obtaining the target user operations, the operation or combination of operations associated with the frequency interval in which the frequency falls may be determined as the specific operation. Here, the size of the frequency interval may be positively correlated with the degree of modification to the animation, meaning that the higher the frequency of target user operations, the greater the modification to the animation, thereby further improving the push effects of animations.

In step S204, the method 20 performs a second adjustment operation on the animations and/or the playback order of the animations in the animation queue. The second adjustment operation may include at least one operation of retaining and adding to other animation queues. In the embodiments of this disclosure, by retaining animations in the animation queue with a high user preference, the optimized animation queue can align with the user's real needs, thereby improving the push effects of animations. By adding animations with a high user preference to other animation queues, these animations can be pushed to more users, thereby increasing the promotion rate and promotion effect of the animations. In some other embodiments, the second adjustment operation may also include adjusting the order of the animation to a front position in the animation queue to enhance users' interest in watching the animation, thereby increasing product sales.

In some embodiments, if the user operations include response operations, in step S204, the method 20 may count a frequency of the response operations and perform the second adjustment operation on the animations and/or the playback order of the animations in the animation queue only when the frequency is greater than a second preset frequency. A higher frequency of response operations indicates a higher user preference for the animation, so performing the second adjustment operation on such animations can further enhance the alignment between the animation queue and the user's real needs, improving the push effects of animations.

In another embodiment, if the user operations include response operations, step S204 may execute the following steps: the method 20 counts a frequency of affirmative response operations among the response operations and performs the second adjustment operation on the animations and/or the playback order of the animations in the animation queue only when the frequency is greater than a second preset frequency. Affirmative response operations are the opposite of the negative response operations described above, referring to response operations that are favorable to the continued playback of the current animation. For example, at the time of playback of Animation 1, an interactive request such as “Continue playback?” with two options: A: Yes, B: No is issued, and the A response operation is an affirmative response operation. Similarly, a higher frequency of affirmative response operations indicates a higher user preference for the animation, so performing the second adjustment operation on such animations can further enhance the alignment between the animation queue and the user's real needs, improving the push effects of animations.

The animation queue optimization method 20 of this disclosure is generally described above in conjunction with FIG. 2. The embodiments of this disclosure adjust the animations and/or the playback order of the animations in the animation queue differently based on whether the recorded user operations corresponding to each animation include target user operations, such that the optimized animation queue retains animations with a high user preference while modifying or deleting animations with a low user preference, so that the optimized animation queue fully meets the user's real needs, achieving targeted and precise animation pushes, improving user experience, and increasing product sales. However, it should be understood by those skilled in the art that the method shown in FIG. 2 is exemplary rather than limiting, and adjustments can be made by those skilled in the art as needed. Multiple embodiments and variations of the methods 10 and 20 of this disclosure will be further described below, including, for example, additional steps that may be included in methods 10 and 20.

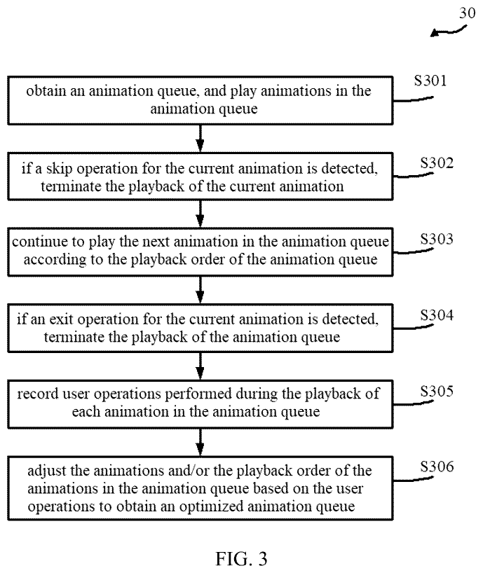

Referring to FIG. 3, which shows a flowchart of an animation queue optimization method 30 according to some embodiments of this disclosure. As shown in FIG. 3, in step S301, the method 30 obtains an animation queue and plays animations in the animation queue. After executing step S301, the method 30 executes step S305, where it records user operations performed during the playback of each animation in the animation queue. Finally, the process reaches step S306. In step S306, the method 30 adjusts the animations and/or the playback order of the animations in the animation queue based on the user operations to obtain an optimized animation queue. The steps S301, S305, and S306 are the same as or similar to the corresponding steps in the previously described methods 10 and 20. For specific implementations, refer to the earlier descriptions, which will not be repeated here.

Multiple embodiments and variations of the method 30 will be further described below. While executing step S301, the method 30 may also execute the steps described below.

If a skip operation for the current animation is detected, the method 30 executes steps S302 and S303. First, in step S302, the method 30 terminates the playback of the current animation. Immediately or concurrently, step S303 is executed, where the method 30 continues to play the next animation in the animation queue according to the playback order of the animation queue. In the embodiments of this disclosure, if a left or right swipe gesture is detected on the animation playback interface, it is considered as detecting a skip operation for the current animation. With this setup, users can freely switch animations based on their preferences to quickly find out products they are interested in, thereby improving user experience and increasing product sales. The playback order of the animation queue is the same as or similar to that described in any of the previous embodiments and will not be repeated here.

In other embodiments, a specific identification link or button for the skip operation may be set on the animation playback interface. If the specific identification link or button is clicked, it is considered as detecting a skip operation for the current animation. This disclosure does not impose specific limitations on this, and those skilled in the art may make adjustments based on actual needs.

If an exit operation for the current animation is detected, the method 30 executes step S304. In step S304, the method 30 terminates the playback of the animation queue to enhance the humanization design of animation playback and improve user experience. In the embodiments of this disclosure, a click button for the exit operation may be pre-set in the upper-right corner or other positions of the animation playback interface, allowing users to click this button to terminate the playback of the animation queue when they no longer wish to watch promotional animations. Further, while terminating the playback of the animation queue, the method 30 may also close the animation playback interface to avoid affecting the user's viewing experience on the promotional page.

In some embodiments, the animation queue optimization methods 10, 20, and 30 provided by the embodiments of this disclosure may further include: if the playback of the current animation queue is not completed and a playback operation for another animation queue is triggered, adjusting the playback order of the other animation queue to be preceded by the current animation queue. This enables the user to first complete watching of an animation queue with ahigh preference, improving user experience and increasing product sales. For example, the other animation queue may be inserted to the end of the current animation queue, adding the other animation queue selected by the user to the currently playing animation queue, allowing for one-time optimization of all animations watched by the user. Alternatively, the other animation queue may not be added to the currently playing animation queue but played directly after the current animation queue ends. In other embodiments, the playback order of the other animation queue may be adjusted to be preceded by the currently playing animation, or the playback may immediately switch to the other animation queue. This disclosure does not impose specific limitations on this.

In yet another embodiment, if the playback of the current animation queue is not completed and a playback operation for another animation queue is triggered, an interactive request for the playback order of the other animation queue may be displayed on the current page, allowing the user to choose the playback order, thereby enhancing the humanization design of animation playback and improving user experience.

In some embodiments, the animation queue optimization methods 10, 20, and 30 provided by the embodiments of this disclosure may further include: if the playback of the current animation queue is completed and a playback operation for another animation queue is triggered, the other animation queue may be played directly.

Multiple embodiments and variations of the animation queue optimization method according to some embodiments of this disclosure are described above in conjunction with FIG. 3. By detecting the user's skip and exit operations on the animation playback interface and responding to these operations to terminate the playback of animations or the animation queue, the humanization design of animation playback is enhanced, and the user experience is improved.

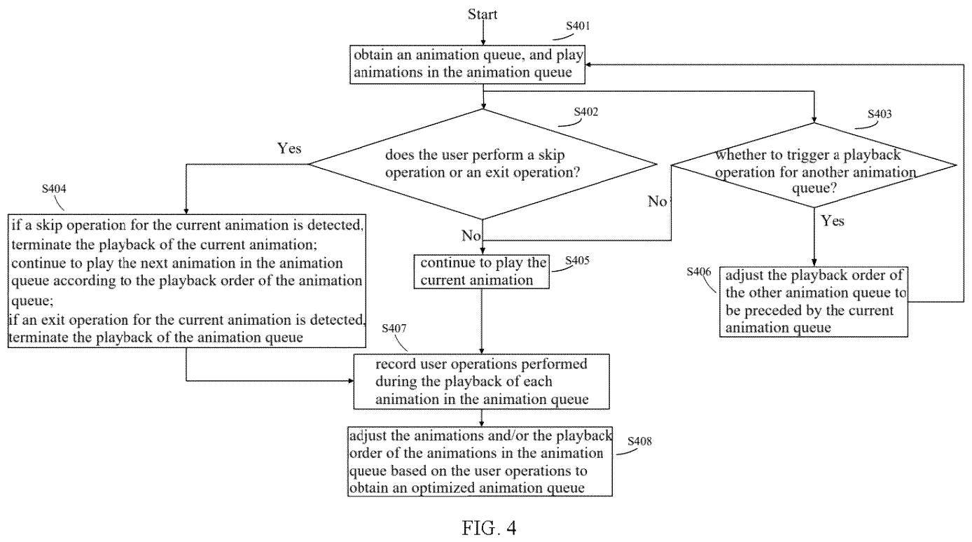

To facilitate understanding of the animation queue optimization methods of the various embodiments of this disclosure, a comprehensive example is provided below in conjunction with FIG. 4. However, this example does not limit this disclosure.

Referring to FIG. 4, which shows an exemplary flowchart of an animation queue optimization method according to some embodiments of this disclosure. As shown in FIG. 4, when a user enters a promotional page or triggers a playback operation for an animation queue on the promotional page, step S401 is executed: obtaining an animation queue and playing animations in the animation queue. At the same time, steps S402 and S403 are synchronously executed. In step S402, it is determined whether the user has performed a skip or exit operation. If a skip or exit operation is detected, step S404 is executed. In step S404, if a skip operation for the current animation is detected, the playback of the current animation is terminated; if an exit operation for the current animation is detected, the playback of the animation queue is terminated. If no skip or exit operation is detected, step S405 is executed, continuing the playback of the current animation. In step S403, it is determined whether the user has triggered a playback operation for another animation queue. If a playback operation for another animation queue is triggered, step S406 is executed: adjusting the playback order of the other animation queue to be preceded by the current animation queue. During the entire process of playing animations in the animation queue, step S407 is continuously executed to record user operations performed during the playback of each animation in the animation queue. Then, after the playback of the animation queue ends or a preset playback count has reached, step S408 is executed. In step S408, the animations and/or the playback order of the animations in the animation queue are adjusted based on the user operations to obtain an optimized animation queue.

In other embodiments, after playing animations in the animation queue, not only the user operations performed during the playback of each animation but also newly added user collection data within a continuous period after the playback of the animation queue ends are recorded. Finally, the animations and/or the playback order of the animations in the animation queue are adjusted based on the user operations and the collection data to obtain an optimized animation queue. For example, the continuous period may be set to 3 or 5 days. The collection data may include product data added to the shopping cart and/or shared with others by the user.

Specifically, the user's collection data may be used to determine the products newly added to the user's collection after watching the animation queue. Then, it is determined whether the animation queue includes these products or products of the same type. If such products exist, it is further determined whether the user operations for the animations featuring these products include target user operations. If target user operations are included, text content for products identical with or of the same type as the collected products is retained at the time of performing the first adjustment operation on the animations. If no target user operations are included, a second adjustment operation is still performed on the animations.

In some embodiments, after the aforementioned adjustment operations are completed, new text content for products identical with or of the same type as the collected products may be further obtained, which is reorganized into new animations, and the new animations are added to the animation queue to obtain an optimized animation queue. For example, the new animations may be added to a front position in the animation queue. In the embodiments of this disclosure, user collection data are combined with user operations to optimize the animation queue, which can accurately fix users' purchasing intent, stimulate their purchasing desire, and increase product sales.

Various embodiments and variations of the animation queue optimization method of this disclosure are described above. The optimized animation queue aligns with user preferences and consumption needs, improving the push effects of animations, enhancing user experience, and increasing product sales. However, it should be understood by those skilled in the art that the various embodiments of this disclosure are exemplary rather than limiting, and modifications can be made by those skilled in the art. Furthermore, the animation queue optimization method provided by the embodiments of this disclosure is not only applicable to promotional animation scenarios such as advertising and marketing but also to all other scenarios related to animation playback, such as character animation playback in game development and animation display in data visualization.

### Exemplary Devices

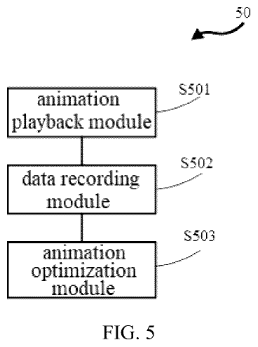

After introducing the methods of the embodiments of this disclosure, the embodiments of this disclosure also provide an apparatus as shown in FIG. 5. Specifically, FIG. 5 shows a structural block diagram of an apparatus for an animation queue optimization method according to some embodiments of this disclosure.

As shown in FIG. 5, the apparatus 50 of this disclosure includes:
an animation playback module 501, configured to obtain an animation queue and play animations in the animation queue;
a data recording module 502, configured to record user operations performed during the playback of each animation in the animation queue; and
an animation optimization module 503, configured to adjust the animations and/or the playback order of the animations in the animation queue based on the user operations to obtain an optimized animation queue.

The above modules may be modules of the same device or different devices. That is, the various steps of the animation queue optimization method of this disclosure may be executed by the same device or by different devices. For example, when the above modules are modules of different devices, the devices may be connected via wired or wireless means for data transmission. For instance, the animation playback module 501 and the data recording module 502 may be modules of a terminal device (such as a mobile phone, computer, or tablet) held by the user, while the animation optimization module 503 may be a module of a remote server. The terminal device and the remote server are communicatively connected via a network. After recording user operations performed during the playback of each animation in the animation queue, the data recording module 502 of the terminal device transmits the user operations to the remote server via the network communicative connection. Upon receiving the user operations, the remote server uses the animation optimization module 503 to adjust the animations and/or the playback order of the animations in the animation queue based on the user operations, thereby obtaining an optimized animation queue.

Based on the above, the embodiments of this disclosure also disclose a computer-readable storage medium having computer instructions stored thereon. When the computer instructions are executed by a processor, the method described in any of the aforementioned embodiments or implementations is performed.

The computer-readable storage medium provided by the embodiments of this disclosure may be, for example, a USB flash drive, being not limited to electrical, magnetic, optical, electromagnetic, infrared, or semiconductor systems, devices, or components, or any combination thereof. More specific examples of the computer-readable storage medium may include, but are not limited to: electrical connections with one or more wires, portable computer disks, hard disks, Random Access Memory (RAM), Read-Only Memory (ROM), Erasable Programmable Read-Only Memory (EPROM or flash memory), optical fibers, portable Compact Disk Read-Only Memory (CD-ROM), optical storage devices, magnetic storage devices, or any suitable combination thereof. In this embodiment, the computer-readable storage medium may be any tangible medium that contains or stores a program, which may be used by or in connection with an instruction executing system, device, or component. The program code contained on the computer-readable storage medium may be transmitted via any suitable medium, including but not limited to: wires, optical cables, RF (radio frequency), etc., or any suitable combination thereof.

The above computer-readable storage medium may be embedded in or external to an apparatus for an animation queue optimization method.

The collection and acquisition of various data in the embodiments of this disclosure comply with relevant laws and regulations and are authorized by data providers. Any organization or individual that needs to obtain external data must do so legally, ensuring data security, and must not illegally collect, use, process, and transmit unauthorized or unprotected data, or illegally trade, provide, or disclose unauthorized or unprotected data.

Although several embodiments of this disclosure have been shown and described herein, it will be obvious to those skilled in the art that such embodiments are provided by way of example only. Numerous variations, changes, and substitutions may occur to those skilled in the art without departing from the spirits and scope of this disclosure. It should be understood that various alternative embodiments of this disclosure described herein may be adopted in the practice of this disclosure. The appended claims are intended to define the protection scope of this disclosure and thus cover equivalents or alternatives within the scope of these claims.

What is claimed is:

1. An animation queue optimization method comprising:
obtaining an animation queue and playing animations in the animation queue;
recording user operations performed during the playback of each animation in the animation queue; and
adjusting the animations and/or the playback order of the animations in the animation queue based on the user operations to obtain an optimized animation queue.

2. The animation queue optimization method according to claim 1, wherein the user operations include autonomous operations performed by the user during animation playback and response operations made by the user in response to interactive requests issued by the animations.

3. The animation queue optimization method according to claim 1, wherein the adjusting of the animations and/or the playback order comprises:
if the user operations include target user operations, performing a first adjustment operation on the animations and/or the playback order of the animations in the animation queue to obtain the optimized animation queue; and
if the user operations do not include target user operations, performing a second adjustment operation on the animations and/or the playback order of the animations in the animation queue to obtain the optimized animation queue.

4. The animation queue optimization method according to claim 3, wherein the target user operations include skip and/or exit operations.

5. The animation queue optimization method according to claim 3, wherein the first adjustment operation includes at least one operation of modifying, reordering, text replacing, duration shortening, and deleting; the second adjustment operation includes at least one operation of retaining and adding to other animation queues.

6. The animation queue optimization method according to claim 1, wherein during the playback of animations in the animation queue, the method further comprises:
if a skip operation for the current animation is detected, terminating the playback of the current animation;
continuing to play the next animation in the animation queue according to the playback order of the animation queue; and
if an exit operation for the current animation is detected, terminating the playback of the animation queue.

7. The animation queue optimization method according to claim 1, wherein the method further comprises:
if the playback of the current animation queue is not completed and a playback operation for another animation queue is triggered, adjusting the playback order of the other animation queue to be preceded by the current animation queue.

8. The animation queue optimization method according to claim 1, wherein after recording the user operations performed during the playback of each animation in the animation queue, the method further comprises:
recording newly added user collection data within a continuous period after the playback of the animation queue ends; and
adjusting the animations and/or the playback order of the animations in the animation queue based on the user operations and the collection data to obtain the optimized animation queue.

9. An apparatus for an animation queue optimization method, the apparatus comprising:
an animation playback module configured to obtain an animation queue and play animations in the animation queue;
a data recording module configured to record user operations performed during the playback of each animation in the animation queue; and
an animation optimization module configured to adjust the animations and/or the playback order of the animations in the animation queue based on the user operations to obtain an optimized animation queue.

10. A non-transitory computer-readable storage medium having computer instructions stored thereon, wherein the computer instructions, when executed by a processor, cause the processor to perform:
obtaining an animation queue and playing animations in the animation queue;
recording user operations performed during the playback of each animation in the animation queue; and
adjusting the animations and/or the playback order of the animations in the animation queue based on the user operations to obtain an optimized animation queue.
